(19) United States
(12) Patent Application Publication
(10) Pub. No.: US 2024/0052132 A1
(43) Pub. Date: Feb. 15, 2024

(54) PROCESS FOR PRODUCING ALKOXYSILOXANES FROM WASTE SILICONE

(71) Applicant: Evonik Operations GmbH, Essen (DE)

(72) Inventors: Wilfried KNOTT, Essen (DE); Horst DUDZIK, Essen (DE); Frauke HENNING, Essen (DE)

(73) Assignee: Evonik Operations GmbH, Essen (DE)

(21) Appl. No.: 18/447,540

(22) Filed: Aug. 10, 2023

(30) Foreign Application Priority Data
Aug. 12, 2022 (EP) 22190105.1

(51) Int. Cl. C08J 11/16; C09J 11/06

(52) U.S. Cl. CPC C08J 11/16; C09J 11/06; C08J 2383/04

(57) ABSTRACT

A process for producing alkoxysiloxanes by thermal reaction of at least one waste silicone with at least one alkali metal alkoxide and at least one alcohol. The process includes a first step of reacting the at least one waste silicone by mixing with at least one alcohol and at least one alkali metal alkoxide with heating, but without removing any potentially occurring water from the reaction mixture, and a second step of neutralizing the reaction mixture resulting from this reaction using at least one Brønsted acid and separating the solid constituents, and subsequently isolating the alkoxysiloxane by thermal separation of volatile compounds.

The invention is in the field of silicones. It relates in particular to a process for producing one or more alkoxysiloxanes from at least one waste silicone by reaction thereof with at least one alkali metal alkoxide and at least one alcohol which is carried out without removal of any potentially occurring water from the reaction mixture. It further relates to alkoxysiloxanes obtainable by such a process and to the use of such alkoxysiloxanes as polymerization-active masses.

The importance of recovering/recycling waste products from economic cycles is ever increasing. This also applies to the recovery of silicone wastes/“end-of-life” silicones. There is therefore a desire to make progress also in this field. Independently thereof, there is also a constant need and thus a constant demand for organically functionalized siloxanes, for example alkoxysiloxanes.

Alkoxysiloxanes are siloxanes comprising one or more, preferably two, alkoxy groups. Linear α,ω-dialkoxysiloxanes are particularly preferred alkoxysiloxanes in the context of the present invention, with linear α,ω-dialkoxypolydimethylsiloxanes being very particularly preferred.

It is therefore desirable to provide an option for directing the recovery of silicone wastes to the production of organically functionalized siloxanes, in particular of alkoxysiloxanes.

Methods for producing alkoxysiloxanes are known per se. In particular, various methods are known which describe the substitution of silicon-bonded, reactive groups by alkoxy radicals. Without going into any great detail about these, in some cases very old, synthetic routes which proceed via the substitution of chlorine and/or hydrogen (dehydrogenative route) we refer, as a reference elucidating the preparative options, to W. Noll, Chemie and Technologie der Silicone, Verlag Chemie GmbH, Weinheim, (1960), pages 60-61, which discusses the conversion of groups that are reactive but bonded to the silane body into alkoxysilanes.

By contrast, a smaller number of works are concerned with routes to alkoxysiloxanes starting from non-functional siloxane bodies.

In U.S. Pat. No. 2,881,199 Bailey et al. claim the production of alkoxy-bearing silanes and also alkoxy-bearing di- and trisiloxanes by acid-catalyzed reaction of cyclic siloxanes with alcohols under reflux conditions and with continuous, azeotropic removal of the water formed during the reaction. As a consequence of the acidic reaction conditions the authors expect the very slow reactions (24 hours) to additionally result in an undesired etherification reaction of the employed alcohol.

Also under acid catalysis Zhurkina et al. (Zh. Obshch. Khim. 1989, 59, 1203-1204) react ethyl orthoformate esters with octamethylcyclotetrasiloxane under mild conditions (16-20° C.) to afford a diethoxyoctamethyltetrasiloxane-containing reaction mixture and isolate this siloxane by subsequent vacuum distillation. The extent to which the use of ethyl orthoformate esters as an exotic water scavenging reagent allows acceptable yields is not referenced, though it is indicated that ethyl formate does not react under these conditions. Base-catalyzed siloxane rearrangements are also known.

Accordingly, the teaching of U.S. Pat. No. 3,477,988 is directed to the base-catalyzed rearrangement of siloxanes in the presence of organophosphorus compounds such as in particular hexamethylphosphoric triamide and even includes the utilization of relatively high molecular weight hydrolyzates, rubbers and elastomers. The need to employ aprotic polar solvents such as the carcinogenic hexamethylphosphoric triamide is a barrier to the use of the teaching in industry.

Chang et al. (J. Polym. Res. 2005, 12, 433-438) report the nucleophilic cleavage of crosslinked polysiloxanes to obtain cyclic siloxane monomers which comprised initially swelling a crosslinked, filled polydimethylsiloxane with 4 or 5 volumes of tetrahydrofuran, toluene or diethylamine at room temperature overnight and subsequently treating the thus-swollen samples with separately prepared, homogeneous solutions of potassium hydroxide in dimethylamine and dissolving them with stirring at room temperature. The authors observed complete dissolution of the silicone rubber constituents over periods of 0.4 to 4 hours. The yields of cyclic products determined after 25 hours of reaction time were in the range from 10% by weight to 77% by weight, wherein the yield of the dissolution experiment performed in diethylamine exceeded the yields determined for the experiments run in tetrahydrofuran, tetrahydrofuran/toluene and toluene.

In K'o Hsueh Tung Pao, 1959, 3, 92-93 Wang and Lin report the decomposition of polyorganosiloxanes by butanolysis, wherein sodium hydroxide is employed as a cleavage reagent and a butanol-water azeotrope is continuously discharged from the reaction system. The authors are unable to solve the dilemma of an alkali-induced polymerization proceeding in effective competition with the alkoxy functionalization which—since it is uncontrolled—produces both short-chain and long-chain cleavage products.

In Zh. Obshch. Khim. 1959, 29, 1528-1534 (Russian Journal of General Chemistry 1959, 29, 1528-1534) Vornokov and Shabarova describe the production of organoalkoxysilanes by cleavage of organosiloxanes with C₄- to C₁₂-alcohols under basic conditions, wherein alkali metal hydroxides, alkali metal alkoxides or the alkali metals themselves are employed.

The authors interpret the reaction of the organosiloxane with alcohol as an equilibrium reaction where it is important to remove water of reaction from the reaction system azeotropically or using an inert, water-insoluble solvent or else preferably by addition of silicic esters (tetralkoxysilanes) as dehydrating agents. Neither the production of alkoxysilanes derivable from alcohols having boiling points below 90° C. nor the attainment of high yields of alkoxysilanes are possible without the use of dehydrating reagents.

By contrast, the publication does not provide a solution for the production of alkoxysiloxanes since, as is understood by those skilled in the art, especially any remaining high-boiling tetraalkoxysilanes (for example tetraethoxysilane b.p. 168° C.) and the condensation products resulting therefrom would entail considerable separation and purification effort.

Petrus et al. report the solvothermal alcoholysis of crosslinked silicone rubber wastes (Macromolecules 2021, 54, 2449-2465) using C₈- to C₁₂-fatty alcohols and describe inter alia the dissolution of shredded silicone rubber in a high-pressure reactor using n-octanol in the temperature range between 180° C. and 240° C. and over reaction times between 16 and 18 hours.

The conversions of the reaction are reported in the range from 22% to 80% and analysis demonstrates that alkoxyoligosiloxanes were formed. To interpret the initially surprising finding that a crosslinked siloxane is apparently amenable to uncatalyzed alcoholysis, Petrus et al. assume that the high digestion temperatures above 200° C. in conjunction with moisture liberate acid from the peroxidically crosslinked silicone rubber, which then catalyzes the cleavage of the Si—O—Si bonds.

Those skilled in the art are aware that this curious laboratory finding is neither suitable for providing a general industrial recycling solution for the multiplicity of all, especially non-peroxidically cured, silicone wastes, nor does it even make it possible to lay out a reliable basis for the solvothermal alcoholysis of any desired, purely peroxidically-cured silicone wastes since the residual contents of active organic peroxide present therein are subject to considerable variations depending on the material and the batch.

In order to try to exclude these random parameters and perform said alcoholysis reaction more effectively, i.e. over shorter reaction times, at reduced temperatures and also at lower catalyst loading, Petrus et al. (ibid.) employ alkali metal aryl oxides aided by the methylsalicylato ligand, and magnesium and zinc aryl oxides and mixed metal aryl oxides with methylsalicylato ligands as catalysts. The best complex in this investigation was found to be the magnesium-sodium-potassium aryl oxide [Mg₂M′₂ (MesalO)₆(THF)₄], where M′=Na, K and MesalO is the methylsalicylato ligand, which allows production of dioctanoxydimethylsilane and 1,3-dioctanoxy-1,1,3,3-tetramethyldisiloxane in yields of 79%/17% over 2 hours at a reaction temperature of 220° C. The complex organometallic preparation of the catalyst requiring protective gas is a severe disadvantage of the process.

Furthermore, Okamoto et al. in Appl. Catalysis A: General 261 (2004), 239-245 describe the depolymerization of polysiloxanes and of SiO₂-filled silicone rubber with dimethyl carbonate and methanol to afford methyl trimethylsilane and di methoxy dimethylsilane and liberate carbon dioxide, wherein not only alkali metal halides but also potassium hydroxide and sodium methoxide are used as catalysts. Performing the process requires an autoclave since the depolymerization is performed at 180° C. over a period of 15 hours. When using solely methanol or dimethyl carbonate only 2 to 3 percent depolymerization achieved. The authors conclude from their experiments that both dimethyl carbonate and methanol must be added to depolymerize polysiloxanes. The need for both a pressure-resistant apparatus and a complex digestion system, as well as lengthy reaction times at high temperature, make this route unattractive for an industrial reaction.

In light of all of these efforts, the technical problem to be solved is defined as that of finding a practicable and very simple synthetic route to alkoxysiloxanes starting from silicone wastes/“end-of-life” silicones which eschews complex chemical systems such as in particular complex solvent mixtures and the preparation and use of costly, exotic catalysts and ideally also high temperature reactions (≥200° C.) in specialized apparatuses.

It has now been found that, surprisingly, this technical problem of producing alkoxysiloxanes from waste silicones is solved by the subject matter of the invention.

The subject matter of the invention is a process for producing one or more alkoxysiloxanes by thermal reaction of at least one waste silicone with at least one alkali metal alkoxide and at least one alcohol, wherein the process comprises
(a) a first step of reacting the at least one waste silicone by mixing with at least one alcohol and at least one alkali metal alkoxide with heating but without removing any potentially occurring water from the reaction mixture, in particular without the use of solvents which form an azeotrope with water and/or without the use of further dehydrating agents, and
(b) a second step of neutralizing the reaction mixture resulting from this reaction using at least one Brønsted acid, optionally with addition of at least one solvent, and separating, especially by filtration, the solid constituents and
(c) subsequently isolating the alkoxysiloxane(s) by thermal separation of volatile compounds.

The term “waste silicone” (or synonymously: “end-of-life silicone”) comprises in the context of the teaching of the invention all silicone-based or silicone-containing products and also products with adhering silicone or contaminated with silicone that are close to reaching and/or have already completely reached the end of their respective technical service life or shelf life or else would be intended for disposal for any other reason. The shelf life or service life describes here the time that a material or an article can be used without the replacement of core components or complete failure. The scope of the teaching also includes silicone adhesives and/or silicone sealants, for example in cartridges, that are close to reaching the end of their shelf life or their expiry date and/or have exceeded this (assessed according to the degree of hardening to be expected and/or which has already occurred), as well as e.g. varyingly old sprue and/or stamping waste from silicone rubber production or similarly also discarded electronic scrap containing silicone-sealed components/component groups. The term “waste silicone” further comprises in the context of the teaching of the invention all silicone wastes, including production wastes. It comprises in particular all those silicones or silicone-containing components or components with adhering silicone or contaminated with silicone that would otherwise be intended for disposal in the usual manner and are accordingly regarded as waste. It thus also comprises for example silicone adhesive and/or sealant cartridges, in particular used silicone adhesive and/or sealant cartridges, intended for disposal which still have silicone residues adhering or present in and on them. The terms “waste silicones”, “silicone wastes” and “end-of-life silicones” are in the context of the present invention to be understood as being synonymous.

In the context of the present invention waste silicone is especially to be understood as meaning corresponding silicone rubbers and/or silicone oils.

The process according to the invention may in each case employ/react one or more waste silicones, i.e. it is also possible to employ/react mixtures of different waste silicones.

When the inventive process for producing alkoxysiloxanes is a process for upcycling silicone wastes, in particular silicone adhesives and/or sealants, silicone rubber wastes and/or silicone oil wastes, preferably with the exception of hexamethyldisiloxane, this represents a preferred embodiment of the invention. Upcycling presently means using low-value silicone wastes to provide higher-value reactive siloxanes, namely alkoxysiloxanes.

When the at least one waste silicone, in particular silicone oils, are composed of D and M units this represents a further preferred embodiment of the invention.

Cited as a reference in relation to the M, D, T, Q nomenclature used in the context of this document to describe the structural units of organopolysiloxanes is W. Noll, Chemie and Technologie der Silicone [Chemistry and Technology of the Silicones], Verlag Chemie GmbH, Weinheim (1960), page 2 ff.

If in the first step (a) at least one additional siloxane selected from the group consisting of hexamethylcyclotrisiloxane (D₃), octamethylcyclotetrasiloxane (D₄), decamethylcyclopentasiloxane (D₅), dodecamethylcyclohexasiloxane (D₆), mixtures of cyclic branched siloxanes of the D/T type and silicone oils is added this represents a preferred embodiment of the invention. It is thus optionally possible in each case to add one or more or any desired mixtures of the abovementioned additional siloxanes in the first step (a).

Cyclic branched siloxanes of the D/T type are cyclic siloxanes constructed from D- and T-units. Mixtures of cyclic branched siloxanes of the D/T type are accordingly mixtures of cyclic siloxanes constructed from D- and T-units. Mixtures of cyclic branched siloxanes of the D/T type are known from the patent literature.

Thus, for example, EP 3401353 A1 describes mixtures of cyclic branched siloxanes comprising D and T units and a process for the production thereof, namely a process comprising (a) an acid-catalysed equilibration of trialkoxysilanes with siloxane cycles and/or α,ω-dihydroxypolydimethylsiloxane in the presence of at least one acidic catalyst and then (b) a hydrolysis and condensation reaction initiated by water addition, and addition of a silicon-containing solvent, followed by (c) distillative removal of the liberated alcohol, of water present in the system and of silicon-containing solvent and neutralization or removal of the acidic catalyst and optionally removal of any salts that may have formed, wherein the silicon-containing solvent preferably comprises the isomeric siloxane cycles octamethylcyclotetrasiloxane (D4), decamethylcyclotetrasiloxane (D5) and/or mixtures thereof, and mass ratios of silicon-containing solvent to the siloxane comprising D and T units of 1:1 to 5:1 are advantageously employed.

EP 3 321 304 A1 describes mixtures of cyclic branched siloxanes comprising D and T units and a process for the production thereof, wherein a trialkoxysilane is reacted with siloxane cycles and/or α,ω-dihydroxypolydimethylsiloxane in a solvent with addition of water and in the presence of at least one acidic catalyst.

EP 3 467 006 A1 describes mixtures of cyclic branched siloxanes comprising D and T units and a process for the production thereof comprising
(a) an acid-catalysed equilibration of trialkoxysilanes with siloxane cycles and/or α,ω-dihydroxypolydimethylsiloxane in the presence of at least one acidic catalyst and then
(b) a hydrolysis and condensation reaction initiated by water addition followed by the addition of a silicon-containing solvent,
(c) with subsequent distillative removal of the liberated alcohol and proportions of the water present in the system,
(d) with subsequent addition of toluene and continuous discharging of residual water remaining in the system,
(e) followed by neutralization or removal of the acidic catalyst and optionally removal of any salts that may have formed,
(f) with subsequent distillative removal of toluene remaining in the system, wherein the silicon-containing solvent preferably comprises the isomeric siloxane cycles octamethylcyclotetrasiloxane (D₄), decamethylcyclotetrasiloxane (D₅) and/or mixtures thereof, and mass ratios of silicon-containing solvent to the siloxane comprising D and T units of 1:1 to 5:1 are advantageously employed.

When the at least one waste silicone has molar masses of >236 g/mol this represents a further preferred embodiment of the invention.

When the process according to the invention for producing alkoxysiloxanes has the feature that the at least one waste silicone is selected from silicone adhesives and/or silicone sealants, preferably silicone adhesive and/or silicone sealant cartridges, in particular silicone adhesive and/or silicone sealant residues in and/or on PE containers, preferably comprising HDPE and/or LDPE, this represents a further preferred embodiment of the invention.

Customary silicone adhesive and/or silicone sealant cartridges normally comprise a silicone adhesive compound and/or silicone sealant compound in a polyethylene container (PE container) which allows expulsion of the silicone adhesive compound and/or silicone sealant compound by application of pressure, wherein the container casing is typically made of HDPE (high-density polyethylene) and the semi-transparent container components (plunger and applicator tip) are normally made of LDPE (low-density polyethylene). HDPE and LDPE are known to those skilled in the art. HDPE has a high density of between 0.94 g/cm 3 and 0.97 g/cm³; LDPE has a density lower than this, of between 0.915 g/cm 3 and 0.935 g/cm³.

As a further significant advantage, the process of the invention thus additionally enables the substantially single-stream recycling of polyethylene, in particular high-density polyethylene (HDPE) originating from preferably used cartridges of silicone adhesive and silicone sealant. Very generally, it allows the recovery of silicone-contaminated PE waste to provide alkoxy-bearing siloxanes with substantially single-stream recovery of polyethylene.

The significance and scale of the specific problem of silicone contamination in HDPE waste is apparent inter alia from a study by Ketenakkoord Kunststofkringloop and Afvalfonds Verpakkingen “Kitkokers in een circulaire economie”, authors I. Gort and S. Haffmans, dated 1 May 2017 (available from Kennisinstituut Duurzaam Verpakken, Zuid Hollandlaan 7, 2596 A L Den Haag, the Netherlands, or from their website at https://kidv.nl/and specifically https://kidv.nl/media/rapportages/kitkokers_in_een_circulaire_economy.pdf?1.1.2-rc.1), which illustrates the dramatic effects minor silicone contamination can have on the reusability of recycled pellet material obtained from waste. For instance, silicone components themselves migrate through the fine, 150 μm melt grids of a pelletizing extruder, thereby ending up in the recycled pellet material and ultimately causing production defects at the plastics processing plant producing e.g. plastic tubing by extrusion blow molding. It is said that even a single particle of silicone is sufficient to cause surface defects and cavities in the polymer, potentially rendering unusable a whole batch that took hours to produce. The contaminated HDPE is a low-quality material and can accordingly also be used only for noncritical purposes. Such silicone-contaminated material from recycled cartridges is currently acceptable only for processing into crude items such as insulating walls, scaffolding planks, boundary posts, railway sleepers and picnic tables, in which the presence of silicone particles is less noticeable, since a smooth surface is not necessarily expected. However, the study does not hold out hope for physical recycling of the silicone component. The silicone residues, in particular residues from used and thus partially emptied silicone sealant cartridges, adhere firmly and—also depending on the stage of the curing process—usually stubbornly to the surrounding cartridge wall, and also to the applicator plunger and to the applicator tip of the cartridge, and cannot be detached easily, and certainly not entirely, from the HDPE that is predominantly used. The study states that all parts of a sealant cartridge are essentially made of polyethylene, the jacket being produced from HDPE and the semi-transparent parts (plunger and applicator tip) often from LDPE (low-density polyethylene).

In the context of the present invention it has now further been found that, surprisingly, in a preferred embodiment of the invention the cured silicone residues remaining in the cartridge can be completely detached from HDPE and LDPE when the preferably comminuted sealant cartridge, cut into small pieces for example, is in a first step reacted by mixing with at least one alkali metal alkoxide and at least one alcohol, optionally in the presence of one or more optional, additional siloxanes, with heating.

This causes the silicone residues to be completely detached from the carrier material which is then obtainable, through filtration and optionally further washing step(s) and drying, as virtually single-stream, silicone-free HDPE or LDPE.

According to the invention the thus-detached silicone can be transformed into an alkoxy-bearing siloxane.

The route discovered according to the invention thus additionally opens up the technical possibility of recovering not only single-stream HDPE, but also—in the context of upcycling from low-value, problematic silicone wastes—high-value reactive siloxanes, namely alkoxysiloxanes, which can be processed into valuable, surface-active additives.

In a preferred embodiment of the invention end-of-life silicone sealant cartridges with adhering silicone can advantageously first be cold-embrittled through contact with liquid nitrogen or even dry ice pellets for example, thereby undergoing a significant reduction in elasticity, and then be appropriately comminuted. Cold-embrittled silicone sealant cartridges can be comminuted for example with the aid of a crusher, a shredder, a mill, a hammer mill, with the aid of rollers or a kneading device or else with the aid of cutting machines. After comminution, the small particle size, silicone-contaminated cartridge material preferably has edge lengths of 1 to 10 mm, in particular of 3 to 6 mm. The comminuted material is preferably reacted by mixing with at least one alkali metal alkoxide and at least one alcohol, optionally in the presence of one or more further optional siloxanes, with heating in a first step.

However, likewise preferably, though less so, it is also possible to initially subject small particle size, silicone-contaminated cartridge material to a preseparation for example according to the teaching of WO 2008/097306 A1 by introducing said material into a liquid having a density between that of the silicone and that of the cartridge plastic and thus effecting a density separation of cartridge material and silicone proportions (corresponds to the formation of density-separated layers).

The limitations of this type of preliminary separation are demonstrated inter alia in the study by Ketenakkoord Kunststofkringloop and Afvalfonds Verpakkingen (see above, pages 22 and 34). For instance, the separation sharpness in the density separation is reduced for example by occluded air inclusions in the silicone that cause buoyancy, thus also resulting in greater or smaller proportions of silicone again ending up in the plastic layer.

It is preferable when the first step of the process according to the invention is performed in a reactor of at least one litre in volume. This corresponds to a preferred embodiment of the invention. Due to the alkaline nature of the reaction medium according to the invention it is preferable when the reactor material is selected from metal, preferably highly alloyed stainless steels, particularly preferably from Hastelloy.

In a preferred embodiment of the invention the reactor itself should—if not electrically heated—preferably be equipped with a heating jacket that permits coupling to a suitable heat transfer medium circuit (for example based on heat-transfer oil or superheated steam).

For the purposes of intensive contacting and easier detachment of the silicone from HDPE/LDPE for example it is preferably possible, for example with regard to silicone-contaminated cartridge material, to proceed such that the small particle size, silicone-contaminated cartridge material is kept in motion in the first step through the use of an effective stirring apparatus.

Should the waste silicone contain for example filler materials, as with regard to silicone-contaminated cartridge material for example, these are likewise liberated from for example any HDPE/LDPE present through the detachment and dissolution of the silicone. In a preferred embodiment of the invention any small particle size HDPE/LDPE particles present may, in the course of the process according to the invention, be separated from the liquid reactive siloxane, namely alkoxysiloxane, optionally interspersed with filler, by filtration, for example with the aid of a coarse sieve; the latter can then be separated from the solid, finely divided filler by settling for example.

Without narrowing the presented teaching it is naturally also possible in advantageous embodiments to find further solutions for the basic process operations discussed here, for example filtrative removal or centrifugal separation of any filler present from the alkoxysiloxane. This corresponds to a preferred embodiment of the invention.

In a preferred embodiment of the invention, for example with regard to silicone-contaminated cartridge material, traces of silicone can be eliminated from any small particle size HDPE/LDPE particles present through suitable washing, for example by thorough contacting with solvents, separation thereof and subsequent drying of the single-stream polymer(s).

According to the invention a first step comprises reacting the at least one, optionally previously mechanically comminuted, waste silicone by mixing with at least one alcohol and at least one alkali metal alkoxide with heating.

The process according to the invention for producing one or more alkoxysiloxanes by thermal reaction of at least one waste silicone with at least one alkali metal alkoxide and at least one alcohol, optionally in the presence of additional optional siloxanes, is preferably performed at standard pressure, i.e. at an external air pressure acting on the apparatus of 1013.25 hPa.

In the context of a further preferred embodiment and advantageously for the achievable yield of alkoxysiloxane the reaction according to the invention may also be performed under superatmospheric pressure conditions in a pressure-resistant reactor. The recorded pressure increase is autogenous in nature and is attributable to the vapor pressure of the system components involved therein. If desired the reactor may preferably also be charged with an inert gas cushion.

For the use of the process according to the invention on an industrial scale it may be advisable and thus preferable to initially evaluate the respective waste silicone with the aid of some preliminary laboratory scale reference experiments in order thus to determine the process parameters that are optimal in each case.

As is understood by those skilled in the art the behaviour of the respective waste silicone in the reaction according to the invention will be influenced inter alia by the degree of polymerization, the degree of crosslinking and, if present, the type and quantity of the filler that may be processed in said waste silicone. Among the waste silicones especially peroxidically postcrosslinked and also heat-treated silicone rubbers always present a particular technical challenge for chemical recycling. The heat treatment of silicone rubber components improves their dimensional stability and prevents them from sweating plasticizers, in particular during use in very hot conditions.

It is preferable when the thermal reaction of the at least one waste silicone in the context of the process according to the invention, for example of corresponding silicone oils and/or silicone rubbers, is undertaken by preference between 50° C. and 200° C., preferably between 80° C. and 180° C., in particular between 120° C. and 170° C.

In the context of the present invention “alkali metal alkoxide” is preferably to be understood as meaning compounds of general formula:

[M⁺][OR⁻],
wherein
M is selected from the group of alkali metals Li, Na or K, preferably Na or K, and
R represents a linear, branched or cyclic alkyl radical, preferably having 1 to 10 carbon atoms, particularly preferably having 1 to 6 carbon atoms, very particularly preferably having 1 or 2 carbon atoms; in a preferred embodiment of the invention the at least one alkali metal alkoxide is accordingly selected from the abovementioned compounds. One or more alkali metal alkoxides may be employed in the process according to the invention. The use of the potassium ethoxide, sodium ethoxide, potassium methoxide and/or sodium methoxide is most preferred.

The known processes for producing alkoxides include chloralkali electrolysis by the amalgam process where sodium amalgam is reacted with alcohol [cf. for example Chemical and Engineering News 22, 1903-06 (1944)].

A further known method is the production of alkoxides from an alkali metal and an alcohol or from an alkali metal hydroxide and an alcohol. Alkoxide production from an alkali metal and a tertiary alcohol is known for example from DE-23 33 634 (Dynamit Nobel) or DE 26 12 642 (Degussa). Production of an alkoxide from an alkali metal hydroxide and a tertiary alcohol is likewise known. The first process variant requires the use of costly alkali metal and the second variant proceeding from alkali metal hydroxide requires that the water formed during the reaction be removed by distillation, thus necessitating correspondingly high thermal outlay.

According to the teaching of DE-A-33 46 131 alkali metal alkoxides are produced from salts by electrolysis, employing an electrolysis cell where a cation exchange membrane separates the electrode spaces. DE-42 33 191.9-43 describes a process which allows production of an alkali metal alkoxide from a salt by electrodialysis.

Also described individually are processes for producing speciality alkoxides, for example the alkoxides of higher and/or polyhydric alcohols.

Alkoxides of higher and/or polyhydric alcohols are known to be producible in principle by transalcoholization, i.e. by substitution of the alkoxide radical of lower alkoxides ROM by reaction with higher alcohols R′OH (wherein R and R′ are alkyl radicals of different carbon chain length and M represents a metal cation) in a liquid reaction mixture at suitable temperature and pressure conditions. In the laboratory jargon this reaction is also referred to as “recooking”. The position of the equilibrium ROM+R′OH⇔ROH+R′OM depends on the acidity of the two alcohols which decreases according to the sequence methanol>primary>secondary>tertiary alcohols [R. T. McIver and J. A. Scott, J. American Chem. Soc. 96 (1973) 2706]. Accordingly, it is said that the production of the alkoxides of secondary alcohols in this way is possible only in exceptional cases and the production of the alkoxides of tertiary alcohols by transalcoholization is entirely unsuccessful [“Methoden der Organischen Chemie” (1963) Vol. 6/2, p. 13]. However, DE-1 254 612 and DE-27 26 491 (both Dynamit Nobel) disclose the production of alkoxides by recooking for higher alcohols too. GB-1 143 897 (Metallgesellschaft) describes the reaction of a monovalent alkali metal alkoxide with a C₂ to C₁₈ alcohol or phenol containing up to six hydroxyl groups, wherein an excess of monohdyric alcohol and/or a hydrocarbon is employed as solvent.

However, the recooking always leads to formation of the low-boiling alcohol ROH (for example methanol) which, for isolation of the desired alkoxide—optionally in addition to the unconverted higher alcohol R′OH—requires removal from the reaction product mixture in some cases with considerable thermal outlay.

Apart from these thermal equilibrium shifts, EP 0776995 (B1) also teaches a process for producing alkoxides under the influence of an electric field, wherein an alcohol is converted into the desired alkoxide by supplying metal ions and the metal ions themselves derive from the electrochemical decomposition of another alkoxide in the electric field. The alkoxide formation and decomposition are carried out in chambers spatially separated by ion exchange membranes.

In the process according to the invention it is preferable when the at least one alkali metal alkoxide is employed in total amounts of 1% to 10% by mass, preferably 2% to 7% by mass, particularly preferably 3% to 6% by mass, based on the total mass of the silicone altogether employed in the reaction (=sum of the mass of the altogether employed at least one waste silicone plus the optionally also added mass of optional, further siloxane). This corresponds to a preferred embodiment of the invention.

It is preferable when the first step (a) of the process according to the invention is performed in the temperature range of 100° C. to 200° C., preferably in the temperature range of 120° C. to 160° C., and over a period of preferably 1 to 12 hours, preferably over a period of 2 to 8 hours, in each case preferably in the absence of solvent. This corresponds to a preferred embodiment of the invention.

In a preferred embodiment of the invention the at least one alcohol employed in the process according to the invention is selected from the group of C₁ to C₁₀ alkanols; i.e. one or more alcohols, i.e. also mixtures of alcohols, may be employed, preferably methanol, ethanol, 1-propanol, isopropanol, 1-butanol, 2-butanol, isobutanol, pentanols, hexanols, heptanols, octanols, nonanols and/or decanols, in each case also including the isomers thereof, particularly preferably methanol and/or ethanol.

In a preferred embodiment the at least one alcohol is employed in the process according to the invention in total amounts of 10% to 200% by mass, preferably 20% to 100% by mass, particularly preferably in amounts of 30% to 80% by mass, based on the total mass of the silicone altogether employed in the reaction (=sum of the mass of the altogether employed at least one waste silicone plus the optionally also added mass of optional, further siloxane).

When the at least one siloxane optionally also added in the first step a) of the process according to the invention is selected from the group consisting of hexamethylcyclotrisiloxane (D₃), octamethylcyclotetrasiloxane (D₄), decamethylcyclopentasiloxane (D₅), dodecamethylcyclohexasiloxane (D₆), mixtures of cyclic branched siloxanes of the D/T type, silicone oils, polydimethylsiloxane diols and α,ω-divinylsiloxanes this represents a further preferred embodiment of the invention; this also includes the use of any desired mixtures of the abovementioned siloxanes. The preferred total addition amount of this at least one siloxane optionally also added in the first step a) may preferably be such that it corresponds to 0.5 to 5 times the amount of the waste silicone altogether to be processed.

Ensuring good stirrability and miscibility in the first step a) of the process according to the invention can preferably have a positive effect on the ease with which the dissolution process is carried out. In this regard it may be preferable for avoidance of high shear and stirring powers, especially when using solid waste silicones having a high degree of polymerization and possible crosslinking, to configure the first step a) of the process according to the invention such that it is sequenced for example, i.e. initially reacting a portion of optionally previously comminuted waste silicone with alkali metal alkoxide(s) and alcohol(s), optionally in the presence of further optional siloxanes, with heating and subsequently evaluating the consistency of the reaction matrix in respect of its stirrability and miscibility. If this reaction matrix proves readily stirrable a further portion of the waste silicone may be added and the process continued in accordance with the invention. This procedure may be continued until the reaction matrix has the desired target rheology. This corresponds to a preferred embodiment of the invention.

In a further preferred embodiment of the invention which may allow an improvement in space-time yield, the first step a) of the process according to the invention may comprise initially charging a sub-amount of the total waste silicone to be digested together with alkali metal alkoxide(s) and alcohol(s) with stirring and heating and then waiting until the reaction matrix has become homogenized and then removing the remaining alcohol by distillation, optionally by application of an auxiliary vacuum. Taking into account the rheology established in each case the reaction mass remaining in the reactor can thus be replenished one or more times through further portionwise addition of waste silicone, thus always ensuring a readily miscible and ultimately homogeneous reaction mass over the entire course of the reaction.

According to the invention the reaction mixture resulting from the first reaction step a) of the process according to the invention is neutralized by addition of at least one Brønsted acid, optionally with addition of at least one solvent, in a second step (b). One or more Brønsted acids may be employed. Anhydrous mineral acids (such as preferably anhydrous sulfuric acid and/or anhydrous perchloric acid) and/or anhydrous organic acids (such as preferably anhydrous acetic acid) may preferably be used for neutralization.

When using anhydrous mineral acid(s) the addition amount thereof is preferably chosen such that stoichiometric equivalence based on the altogether employed alkali metal alkoxide is achieved. When using the markedly weaker, anhydrous organic acid(s) (for example anhydrous acetic acid) it is preferable to choose a marked stoichiometric excess of acid based on altogether employed alkali metal alkoxide. This is preferably up to a 50% excess.

The usage amount of the altogether employed Brønsted acid is thus preferably chosen such that it is in the range from stoichiometric equivalence to a 50% stoichiometric excess, in each case based on altogether employed alkali metal alkoxide.

Especially when the amount of salt expected from the neutralization step according to the invention stands in the way of easy filtration it is preferable to provide for the use of at least one solvent. One or more solvents may optionally be employed.

One or more solvents which are preferably suitable according to the invention are those which are themselves chemically inert with regard to the reaction system and which promote dilution/dispersion of the constituents of the neutralization step. It is preferable when the at least one solvent is selected from the group consisting of alkanes, alkylaromatics and alcohols. The use of alkylaromatics, such as preferably toluene and/or xylenes, is particularly preferred. Likewise preferably employable are siloxanes selected from the group consisting of hexamethylcyclotrisiloxane (D₃), octamethylcyclotetrasiloxane (D₄), decamethylcyclopentasiloxane (D₅) and dodecamethylcyclohexasiloxane (D₆) and mixtures thereof.

The solid constituents resulting from the neutralization may then preferably be separated, in particular by filtrative removal. Subsequently, especially after filtrative removal of the solid constituents resulting from the neutralization, the volatile compounds are subjected to thermal separation and the alkoxysiloxane is isolated.

This affords the corresponding one or more alkoxysiloxanes in simple fashion according to the invention.

The invention accordingly further provides alkoxysiloxanes produced by the process according to the invention.

The alkoxysiloxanes obtained according to the invention may be used as starting materials for polymerization-active masses and then preferably by addition of suitable crosslinking catalysts as sealants and/or adhesives, optionally also blended with further crosslinking silanes and/or siloxanes, optionally filled with fillers and/or pigments and/or unfilled.

The invention thus further provides for the use of alkoxysiloxanes obtained according to the invention as polymerization-active masses, preferably as adhesives and/or sealants.

The alkoxysiloxanes obtained according to the invention are furthermore also suitable for example as starting materials for producing SiOC-bonded polyether siloxanes by transesterification with polyetherols in the presence of zinc acetylacetonate as catalyst, such as disclosed in European patent application EP 3438158 (B1).

The invention thus further provides for the use of alkoxysiloxanes obtained according to the invention for producing SiOC-bonded polyethersiloxanes by transesterification of the alkoxysiloxanes with polyetherols in the presence of zinc acetylacetonate as catalyst.

If for example particular number-average siloxane chain lengths are desired prior to the further processing described here, the alkoxysiloxanes obtained according to the invention may optionally also be subjected to a downstream, preferably acid-catalyzed, equilibration to establish the target chain lengths.

It is likewise possible to convert the alkoxysiloxanes obtained according to the invention into the corresponding acetoxy-bearing siloxanes for example through reaction in a reaction medium comprising acetic anhydride, perfluoroalkanesulfonic acid (in particular trifluoromethanesulfonic acid) and preferably acetic acid with continuous discharging of the respective acetic ester, as described in patent application EP 3663346 A1, and to likewise use these as reactive intermediates, such as for example for producing SiOC-bonded polyether siloxanes or else as starting materials for polymerization-active masses.

### EXAMPLES

The examples which follow serve merely to elucidate the present invention to those skilled in the art and do not constitute any limitation of the subject matter of the invention whatsoever. ²⁹Si-NMR spectroscopy was used for reaction monitoring in all examples.

In the context of the present invention the ²⁹Si-NMR samples are analysed at a measurement frequency of 79.49 MHz in a Bruker Avance III spectrometer equipped with a 287430 sample head with gap width of 10 mm, dissolved at 22° C. in CDCl₃ and against a tetramethylsilane (TMS) external standard [δ(²⁹Si)=0.0 ppm].

Unless otherwise stated all percentages are to be understood as meaning weight percentages.

### Example 1 (Inventive)

30 g of an elastic silicone rubber cut into small, irregular pieces of about 5 to 10 mm in diameter together with 70 g of D₅, 30 g of methanol and 5 g of potassium methoxide are weighed into a 300 ml pressure reactor from Roth fitted with a magnetic stirrer, a manometer and a heating mantle with an integrated thermocouple. With stirring of the reaction mass the sealed pressure reactor is then rapidly heated to 160° C. for 4 hours.

The reactor is allowed to cool and decompress and the free-flowing contents thereof now interspersed with only a few visible solids fractions (diameter<1 mm) are transferred into a glass beaker with a magnetic stirrer bar. The intermediate resulting from the reaction is stirred at 22° C. and admixed with 8.3 g of anhydrous acetic acid (50% stoichiometric excess). After 30 minutes the solid constituents are separated via a pleated filter. The isolated filtercake consists of a finely divided precipitate.

The obtained filtrate is freed of volatile constituents at a bottoms temperature of 60° C. and an applied auxiliary vacuum of <5 mbar on a rotary evaporator, wherein a slight clouding of the bottoms by post-precipitation is observed. Refiltration via a pleated filter affords a colourless clear liquid whose accompanying ²⁹ Si-NMR spectrum verifies that a linear α,ω-dimethoxypolydimethylsiloxane of average chain length N=39.7 has been formed.

### Example 2 (Inventive)

30 g of a crosslinked silicone rubber cut into pieces of irregular geometry of on average about 3 to 4 mm in size together with 70 g of ethanol are initially charged with stirring into a 500 ml four-necked flask fitted with a reflux cooler and a KPG stirrer and internal thermometer and admixed with 5 g of pulverulent potassium methoxide (manufacturer).

The mixture is allowed to react at 80° C. over a period of 6 hours under light reflux with further stirring. As soon as 45 minutes after reaching the target temperature the reaction mass had achieved homogeneity and miscibility such that a further 30 g of the comminuted, crosslinked silicone rubber is added. After a further 15 minutes the mixture is replenished with a further portion of 30 g of the silicone rubber. After a further 45 minutes a further 30 g portion of the silicone rubber is introduced into the reaction mass.

At the end of the first step according to the invention the flask contents consist of a viscous homogeneous phase.

The batch is subsequently cooled to 60° C., admixed with 5.3 g of anhydrous acetic acid (50% excess) and stirred for 30 minutes at this temperature. The solids fractions are separated using a filter press (K 300 filter disc). A sample of the thus obtained, colourless residue is analyzed by 29 Si-NMR spectroscopy. The characteristic signal positions of the accompanying 29 Si-NMR spectrum demonstrate that a linear α,ω-dimethoxypolydimethylsiloxane having an average chain length of about 10.3 was formed. In addition, the spectrum indicates the presence of a trace of Q structures (signal positions in the range between about −101 to −108 ppm).

1: A process for producing one or more alkoxysiloxanes by a thermal reaction of at least one waste silicone with at least one alkali metal alkoxide and at least one alcohol,
wherein the process comprises:
(a) reacting the at least one waste silicone by mixing with at least one alcohol and at least one alkali metal alkoxide with heating but without removing any potentially occurring water from the reaction mixture, and
(b) neutralizing the reaction mixture resulting from the reacting by neutralization with at least one Brønsted acid, and optionally with an addition of at least one solvent, and separating by filtration the solid constituents, and
(c) subsequently isolating the alkoxysilane(s) by thermal separation of volatile compounds.

2: The process according claim 1,
wherein in the reacting at least one additional siloxane is selected from the group consisting of hexamethylcyclotrisiloxane (D3), octamethylcyclotetrasiloxane (D4), decamethylcyclopentasiloxane (D5), dodecamethylcyclohexasiloxane (D6), mixtures of cyclic branched siloxanes of the D/T type, silicone oils, polydimethylsiloxane diols and α,ω-divinylsiloxanes is added.

3: The process according to claim 1,
wherein the reacting is undertaken without a water-binding silicic esters.

4: The process according to claim 1,
wherein the at least one alkali metal alkoxide conforms to the general formula [M+] [OR−],
wherein
M is selected from the group consisting of alkali metals Li, Na or K, and
R represents a linear, branched or cyclic alkyl radical.

5: The process according to claim 1,
wherein the at least one alcohol employed in the reacting is selected from the group consisting of linear, branched and cyclic C₁ to C₁₀ alkanols, and an isomer relevant thereof to the selected group is included.

6: The process according to claim 1,
wherein the at least one alcohol is employed in total amounts of 10% to 200% by mass, based on the total mass of a silicone altogether employed in the reaction which equals the sum of the mass of the altogether employed at least one waste silicone plus the optionally also added mass of optional, further siloxane.

7: The process according to claim 1,
wherein the at least one alkali metal alkoxide is employed in a total amount of 1% to 10% by mass, based on the total mass of a silicone altogether employed in the reaction which equals the sum of the mass of altogether employed at least one waste silicone plus the optionally also added mass of optional, further siloxane.

8: The process according to claim 1,
wherein the at least one Brønsted acid added in the neutralizing is an anhydrous mineral acid and/or an anhydrous organic acid.

9: The process according to claim 1,
wherein the at least one solvent is selected from the group consisting of alkanes, alkylaromatics, alcohols, hexamethylcyclotrisiloxane (D3), octamethylcyclotetrasiloxane (D4), decamethylcyclopentasiloxane (D5) and dodecamethylcyclohexasiloxane (D6) is added in the neutralizing.

10: The process according to claim 1,
wherein the thermal reaction of the at least one waste silicone in the reacting is undertaken at temperatures between 50° C. and 200° C.

11: The process according to claim 1,
wherein the thermal reaction of the at least one waste silicone in the reacting is performed over a period of 1 to 12 hours.

12: The process according to claim 1,
wherein the thermal reaction of the at least one waste silicone in the reacting is performed at a pressure greater than 1013.25 hPa.

13: The process according to claim 1,
wherein the at least one waste silicone is mechanically comminuted before the thermal reaction.

14: An alkoxysiloxanes obtainable in the process according to claim 1.

15: The alkoxysiloxanes according to claim 14,
which are suitable as polymerization-active masses.

16: The alkoxysiloxanes according to claim 14,
which are suitable for producing SiOC-bonded polyether siloxanes by transesterification of the alkoxysiloxanes with polyetherols in the presence of zinc acetylacetonate as catalyst.

17: The process according to claim 1,
wherein reacting the at least one waste silicone by mixing with at least one alcohol is completed without solvents which form an azeotrope with water and/or without dehydrating agents.

18: The process according to claim 1,
wherein the reacting is undertaken without tetraalkoxysilanes.

19: The process according to claim 1,
wherein the at least one alkali metal alkoxide conforms to the general formula [M+] [OR−],
wherein
M is selected from the group of alkali metals Na or K, and
R represents a linear, branched or cyclic alkyl radical having 1 to 10 carbon atoms.

20: The process according to claim 1,
wherein the at least one alcohol employed in the reacting is selected from the group consisting of linear, branched and cyclic C₁ to C₁₀ alkanols selected from the group of methanol, ethanol, 1-propanol, isopropanol, 1-butanol, 2-butanol, isobutanol, pentanols, hexanols, heptanols, octanols, nonanols and/or decanols, in each case also including the isomers thereof selected from the group of methanol and/or ethanol.

21: The process according to claim 1,
wherein the at least one alcohol is employed in total amounts of 20% to 100% by mass, based on the total mass of a silicone altogether employed in the reaction which equals the sum of the mass of the altogether employed at least one waste silicone plus the optionally also added mass of optional, further siloxane.

22: The process according to claim 1,
wherein the at least one alkali metal alkoxide is employed in a total amount of 2% to 7% by mass, based on the total mass of a silicone altogether employed in the reaction which equals the sum of the mass of altogether employed at least one waste silicone plus the optionally also added mass of optional, further siloxane.

23: The process according to claim 1,
wherein the at least one Brønsted acid added in the neutralizing is anhydrous mineral acid and/or anhydrous organic acid, selected from the group of anhydrous sulfuric acid, anhydrous perchloric acid and/or anhydrous acetic acid.

24: The process according to claim 1,
wherein the thermal reaction of the at least one waste silicone in the reacting is undertaken at temperatures between 80° C. and 180° C.

25: The process according to claim 1,
wherein the thermal reaction of the at least one waste silicone in the reacting is performed over a period of 2 to 8 hours.

26: The alkoxysiloxanes according to claim 14,
which are suitable as adhesives and/or sealants.
